(19) United States
(12) Patent Application Publication
(10) Pub. No.: US 2023/0230284 A1
(43) Pub. Date: Jul. 20, 2023

(54) METHOD FOR ENCODING AND DECODING RESIDUAL SIGNAL BASED ON PERIODICITY OF PHASE SIGNAL AND APPARATUS THEREOF

(71) Applicants: ELECTRONICS AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR); INDUSTRY-UNIVERSITY COOPERATION FOUNDATION HANYANG UNIVERSITY ERICA CAMPUS, Ansan-si (KR)

(72) Inventors: Kwan Jung OH, Daejeon (KR); Hui Yong KIM, Daejeon (KR); Hyun Min BAN, Yongin-si (KR); Seung Mi CHOI, Daejeon (KR); Jun Yeong CHA, Suwon-si (KR); Hyun Suk KO, Ansan-si (KR)

(73) Assignees: ELECTRONICS AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR); INDUSTRY-UNIVERSITY COOPERATION FOUNDATION HANYANG UNIVERSITY ERICA CAMPUS, Ansan-si (KR)

(21) Appl. No.: 18/072,146

(22) Filed: Nov. 30, 2022

(30) Foreign Application Priority Data
Nov. 30, 2021 (KR) 10-2021-0169185
Nov. 30, 2022 (KR) 10-2022-0163787

(51) Int. Cl. G06T 9/00

(52) U.S. Cl. CPC G06T 9/00

(57) ABSTRACT

The residual signal encoding and decoding method and apparatus based on a periodicity on phase signal are disclosed. One embodiment on a method for decoding an image, the method comprising: generating a prediction signal for a current signal, decoding an encoded residual signal from a bitstream, generating an initial reconstructed signal based on the prediction signal and the residual signal, and generating a transformed reconstructed signal by transforming a value of the initial reconstructed signal to have a size value of a preset range, wherein the generating of the transformed reconstructed signal generates the transformed reconstructed signal from the value of the initial reconstructed signal by using a clipping function with a minimum value of the preset range and a maximum value of the preset range as input values, and wherein the preset range is a period range of a signal.

### BACKGROUND OF THE INVENTION

### Field of the Invention

The present disclosure relates to a prediction encoding and/or decoding method for a phase signal by considering periodicity in order to provide a technique of enhancing compression efficiency that not only reduces a compression bit rate in prediction encoding of a phase signal but also minimizes quality degradation of a decoded image. According to the present disclosure, spatial correlation between phase residual signals may be increased, and thus compression performance of a residual signal may be improved.

### Description of the Related Art

Holography is a technology of representing a complete three-dimensional image by solving the vergence-accommodation conflict problem of the existing stereoscopy method that handles the amplitude and phase information of lights. Holography is a technology that obtains a hologram by recording an interference pattern, which is generated by interference between an object beam reflected in a subject and a reference beam, and represents a three-dimensional image in a stereoscopic space by illuminating the obtained hologram with the reference beam.

Conventionally, when a residual signal of a phase signal like a hologram is encoded, transform coding is performed without considering periodicity of the phase signal.

### SUMMARY

The present disclosure is directed to provide an encoding and/or decoding method for a residual signal of a phase signal in consideration of periodicity and thus to enhance compression efficiency by not only reducing a compression bit rate in encoding the phase signal but also minimizing quality degradation of a decoded phase signal and a hologram image.

The technical problems solved by the present disclosure are not limited to the above technical problems and other technical problems which are not described herein will become apparently understandable to those skilled in the art from the following description.

A method for decoding an image, the method comprising: generating a prediction signal for a current signal, decoding an encoded residual signal from a bitstream, generating an initial reconstructed signal based on the prediction signal and the residual signal, and generating a transformed reconstructed signal by transforming a value of the initial reconstructed signal to have a size value of a preset range, wherein the generating of the transformed reconstructed signal generates the transformed reconstructed signal from the value of the initial reconstructed signal by using a clipping function with a minimum value of the preset range and a maximum value of the preset range as input values, and wherein the preset range is a period range of a signal.

In one embodiment, wherein the residual signal is a signal that is adjusted based on a similarity between neighbor residual signals of a region adjacent to the residual signal.

In one embodiment, wherein the residual signal is a signal that is adjusted based on at least one of a number of neighbor residual signals that are referred to, a direction of referring to a neighbor residual signal, a reference distance, and a reference point.

In one embodiment, wherein the reference point is determined based on at least one of a position of a signal and a value of a signal.

A method for encoding an image, the method comprising: generating a prediction signal for an input signal, generating an initial residual signal based on the input signal and the prediction signal, adjusting the initial residual signal based on a neighbor residual signal value that is a residual signal for a signal of a region adjacent to the input signal, and encoding the adjusted residual signal.

In one embodiment, wherein the initial residual signal is generated by considering periodicity of the input signal and the prediction signal.

In one embodiment, wherein a size of the initial residual signal is generated so as not to exceed a maximum value of a period range of the input signal and the prediction signal.

In one embodiment, wherein the adjusting of the initial residual signal adjusts a value of the initial residual signal based on a similarity between the initial residual signal and the neighbor residual signal.

In one embodiment, wherein the adjusting of the initial residual signal adjusts the initial residual signal based on at least one of a number of neighbor residual signals that are referred to, a direction of referring to a neighbor residual signal, a reference distance, and a reference point.

In one embodiment, wherein the reference point is determined based on at least one of position of a signal and a value of a signal.

In one embodiment, wherein the adjusting of the initial residual signal determines whether or not to adjust the initial residual signal based on a similarity between the neighbor residual signal and each of the adjusted residual signal that is generated by adjusting the initial residual signal based on the initial residual signal and periodicity of the signal.

In one embodiment, wherein the adjusting of the initial residual signal determines to use the adjusted residual signal, when a similarity between the adjusted residual signal and the neighbor residual signal is higher than a similarity between the initial residual signal and the neighbor residual signal.

In one embodiment, wherein the similarity is determined based on a sum of a distance for at least one of each of the neighbor residual signal.

In one embodiment, comprising: decoding the adjusted residual signal that is encoded, generating an initial reconstructed signal based on the prediction signal and the adjusted residual signal, and generating a transformed reconstructed signal by transforming a value of the initial reconstructed signal to have a size value in a preset range, wherein the generating of the transformed reconstructed signal generates the transformed reconstructed signal from the value of the initial reconstructed signal by using a clipping function that has a minimum value of the preset range and a maximum value of the preset range as input values.

A recording medium storing a bitstream generated by an image encoding method, wherein the image encoding method comprises: generating a prediction signal for an input signal, generating an initial residual signal based on the input signal and the prediction signal, adjusting the initial residual signal based on a neighbor residual signal value that is a residual signal for a signal of a region adjacent to the input signal, and encoding the adjusted residual signal.

The features briefly summarized above with respect to the disclosure are merely exemplary aspects of the detailed description of the disclosure that follows, and do not limit the scope of the disclosure.

According to the present disclosure, spatial correlation between phase residual signals may be increased, and thus compression performance of a residual signal may be improved.

The technical problems solved by the present disclosure are not limited to the above technical problems and other technical problems which are not described herein will become apparently understandable to those skilled in the art from the following description.

The advantageous effects that can be obtained in the present disclosure are not limited to the effects mentioned above, and other effects not mentioned may be clearly understood by those skilled in the art from the description below.

### BRIEF DESCRIPTION OF THE DRAWINGS

FIG. 1 is a block diagram showing a configuration of an encoding apparatus according to an embodiment to which the present disclosure is applied.

FIG. 2 is a block diagram showing a configuration of a decoding apparatus according to an embodiment and to which the present disclosure is applied.

FIG. 3 is a view illustrating an embodiment of a candidate of a residual signal that can be selected based on periodicity of a phase signal.

FIG. 4 is a view illustrating an embodiment of a candidate of a residual signal that can be selected based on periodicity of a phase signal.

FIG. 5 is a view illustrating an embodiment of a method of generating a residual signal by using periodicity of a signal.

FIG. 6 is a view illustrating an embodiment of a configuration of an apparatus for encoding a digital hologram of an input signal.

FIG. 7 is an embodiment of generating an initial residual signal based on difference between an original signal and a prediction signal.

FIG. 8 is an embodiment of generating an initial residual signal based on a difference value based on periodicity of an original signal and a prediction signal.

FIG. 9 is a view illustrating an embodiment of a method of determining a reference point.

FIG. 10 is a view illustrating an embodiment of a method of generating a residual signal according to a referencing method.

FIG. 11 is a view illustrating an embodiment of a residual signal adjustment method that determines similarity between residual signals by using two neighbor residual signals.

FIG. 12 is a view illustrating an embodiment of a residual signal adjustment method that determines similarity between residual signals by using three neighbor residual signals.

FIG. 13 is a view illustrating an embodiment of a residual signal adjustment method that determines similarity between residual signals by using four neighbor residual signals.

FIG. 14 is a view illustrating an embodiment of a method of generating a residual signal by considering spatial similarity.

FIG. 15 is a view illustrating an embodiment of an adjusted residual signal range that is calculated by adjusting a range of an initial residual signal.

FIG. 16 is a view illustrating an embodiment of an adjusted residual signal range that is calculated by adjusting a range of an initial residual signal.

FIG. 17 is a view illustrating an embodiment of an adjusted residual signal range that is calculated by adjusting a range of an initial residual signal.

FIG. 18 is a view illustrating an embodiment of a residual signal adjustment method that determines similarity between residual signals by using five or more neighbor residual signals.

FIG. 19 is a view illustrating embodiments of a referencing method of a residual signal.

### DETAILED DESCRIPTION OF THE INVENTION

Hereinafter, embodiments of the present invention will be described in detail with reference to the accompanying drawings, which will be easily implemented by those skilled in the art. However, the present invention may be embodied in many different forms and is not limited to the embodiments described herein.

In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

When an element is referred to as being “connected to” or “coupled with” another element, it can not only be directly connected or coupled to the other element but also it can be understood that intervening elements may be present. Also, when a specific element is referred to as being “included” or “comprising”, elements other than the corresponding element are not excluded, but additional elements may be included in embodiments of the present invention or the scope of the present invention.

It will be understood that, although the terms including ordinal numbers such as “first”, “second”, etc. these terms are only used to distinguish one element from another and are not to limit the order and the priority of the elements. For example, the ‘first’ component in one embodiment may be named the ‘second’ component in other one embodiment, and the ‘second’ component in one embodiment may also be similarly named the ‘first’ component in other embodiment. The components as used herein may be independently shown to represent their respective distinct features, but this does not mean that each component should be configured as a separate hardware or software unit. In other words, the components are shown separately from each other for ease of description. At least two of the components may be combined to configure a single component, or each component may be split into a plurality of components to perform a function. Such combination or separation also belongs to the scope of the present invention without departing from the gist of the present invention.

In the present disclosure, all of the constituent elements described in various embodiments should not be construed as being essential elements but some of the constituent elements may be optional elements. Accordingly, embodiments configured by respective subsets of constituent elements in a certain embodiment also may fall within the scope of the present disclosure. In addition, embodiments configured by adding one or more elements to various elements also may fall within the scope of the present disclosure.

Furthermore, terms such as “ . . . part”, “ . . . unit”, and “ . . . module” mean a unit which processes one or more functions or operations, and may be implemented by hardware, software, or a combination of hardware and software.

Overview of Digital Holography Technology

Holography is a technology that reproduces a complete three-dimensional image by resolving the vergence-accommodation conflict problem of the existing stereo method dealing with the amplitude and phase information of light. Holography is a technology that obtains a hologram by recording an interference pattern generated by interference between object light and reference light reflected from a subject and reproduces a three-dimensional image in a three-dimensional space by projecting reference light onto the obtained hologram.

Digital holography technology refers to obtaining three-dimension image data with image obtaining device such as Change Coupled Device (CCD), by using holography and reproducing hologram image with a display device such as Spatial Light Modulator (SLM). An interference pattern obtained from a camera such as a CCD or generated by a numerical method may be referred to as a digital hologram.

SLM broadly refers to any kind of device that modulates light according to position. The beam projectors and shadow arts using shadow can also be seen as an example of using the spatial light modulation.

A technique for obtaining a holographic image can be divided into a method for obtaining 3D information of a real object and a method for obtaining an image from computer graphics.

Technologies, which is able to obtain the real objects, include self-interference technology, optical scanning holography, and computer-generated hologram (CGH). Computer Generated Holography (CGH) is a research field that synthesizes holographic images by numerically simulating the propagation of light waves. Computer Generated Hologram (CGH) is a holographic image obtained by numerically simulating the propagation of light waves.

Phase-only Hologram: In a hologram, a complex signal can be represented by both amplitude and phase. A phase hologram refers to a hologram composed of only phase information in complex data.

The present invention relates to a compression encoding/decoding method for a phase signal such as a phase hologram.

### Description of Terms

Encoder: may mean an apparatus performing encoding.
Decoder: may mean an apparatus performing decoding
Block: may mean an M×N array of a sample. Herein, M and N may mean positive integers, and the block may mean a sample array of a two-dimensional form.
Unit: may refer to an encoding and decoding unit. When encoding and decoding an image, the unit may be a region generated by partitioning a single image. In addition, the unit may mean a subdivided unit when a single image is partitioned into subdivided units during encoding or decoding. That is, an image may be partitioned into a plurality of units. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each chroma component block. The unit may have various sizes and forms, and particularly, the form of the unit may be a two-dimensional geometrical figure such as a square shape, a rectangular shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Reconstructed Neighbor block: may mean a neighbor block adjacent to a current block and which has been already spatially/temporally encoded or decoded. Herein, the reconstructed neighbor block may mean a reconstructed neighbor unit.

Unit Depth: may mean a partitioned degree of a unit. In a tree structure, the highest node (Root Node) may correspond to the first unit which is not partitioned. Also, the highest node may have the least depth value.

Symbol: may mean at least one of a syntax element, a coding parameter, and a transform coefficient value of an encoding/decoding target unit.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, and tile header information.

Bitstream: may mean a bitstream including encoded image information.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of value of an intra prediction mode, an inter prediction mode, intra prediction direction, motion information, motion vector, a reference picture list, a motion vector predictor, a motion merge candidate, a transform type, a transform size, whether to use additional transform, in-loop filter information, whether residual signal exists, quantization parameter, syntax model, transform coefficient, a level of transform coefficient, coded block pattern (CBP), coded block flag (CBF), an order of displaying/outputting image, slice information, tile information, picture type, whether merge mode is used, whether skip mode is used, a size of a block, a depth of a block, information on block partition, a size of unit, a depth of unit, information on unit partition and/or statistics may be included in the coding parameter.

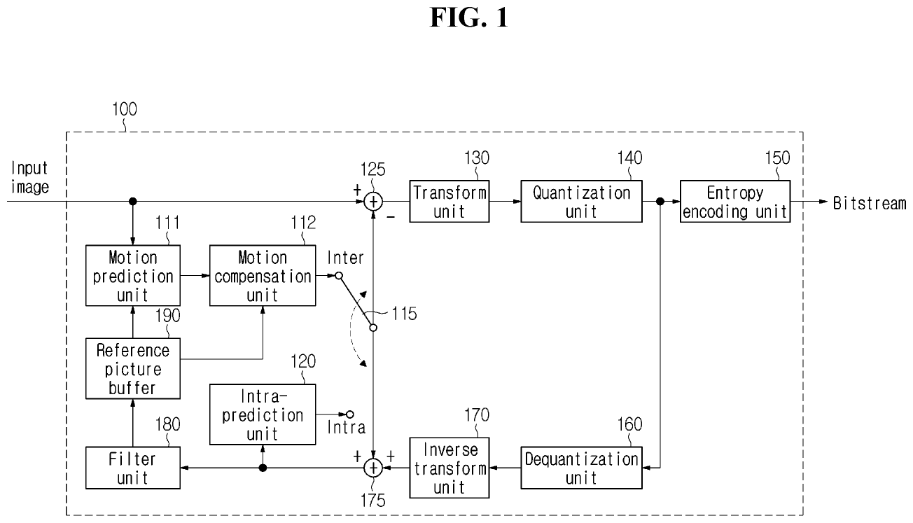

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, an inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a pixel value of a block that has been already encoded/decoded and is adjacent to a current block as a reference pixel. The intra-prediction unit 120 may perform spatial prediction by using a reference pixel, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. The reference image may be stored in the reference picture buffer 190.

The motion compensation unit 112 may generate a prediction block by performing motion compensation using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter prediction or motion compensation may be differently performed depending on the determined mode.

The subtractor 125 may generate a residual block by using a residual of an input block and a prediction block. The residual block may be called as a residual signal.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized coefficient level by quantizing the transform coefficient to a quantization parameter and output the quantized transform coefficient level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of sample information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level (quantized level), the entropy encoding unit 150 may change a two-dimensional block form coefficient into a one-dimensional vector form by using a transform coefficient scanning method. For example, the entropy encoding unit may change vector into a 1D vector block form by scanning the coefficients of the block using up right scanning. Depending on the size of the transform unit and the intra-prediction mode, vertical scan or horizontal scan may be used instead of upright scan. That is, it may be determined which scan method among upright scan, vertical scan, and horizontal scan is used according to the size of the transform unit and the intra-prediction mode.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of value of an intra prediction mode, an inter prediction mode, intra prediction direction, motion information, motion vector, a reference picture list, a motion vector predictor, a motion merge candidate, a transform type, a transform size, whether to use additional transform, in-loop filter information, whether residual signal exists, quantization parameter, syntax model, transform coefficient, a level of transform coefficient, coded block pattern (CBP), coded block flag (CBF), an order of displaying/outputting image, slice information, tile information, picture type, whether merge mode is used, whether skip mode is used, a size of a block, a depth of a block, information on block partition, a size of unit, a depth of unit, information on unit partition and/or statistics may be included in the coding parameter.

The residual signal may mean the difference between the original signal and the prediction signal. Or the residual signal may be a signal generated by transforming the difference between the original signal and the prediction signal. Or the residual signal may be a signal generated by transforming and quantizing the difference between the original signal and the prediction signal. The residual block may be signal in a unit of block.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image. Inverse quantization and inverse transformation on the encoded the current image for decoding may be processed.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated.

A reconstructed block may pass through the filter unit 180. The filter unit 180 may apply at least one of a deblocking filter, a sample adaptive offset (SAO), and an adaptive loop filter (ALF) to the reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based samples included in several rows or columns which are included in the block. When a deblocking filter is applied to a block, a strong filter or a weak filter can be applied depending on the required deblocking filtering strength. In addition, in applying the deblocking filter, horizontal filtering and vertical filtering can be processed in parallel when vertical filtering and horizontal filtering are performed.

In order to compensate an encoding error, a proper offset value may be added to a pixel value by using a sample adaptive offset. The sample adaptive offset may correct an offset of a deblocked image from an original image by a pixel unit. A method of partitioning pixels of an image into a predetermined number of regions, determining a region to which an offset is applied, and applying the offset to the determined region, or a method of applying an offset in consideration of edge information on each pixel may be used.

The adaptive loop filter may perform filtering based on a comparison result of the filtered reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190.

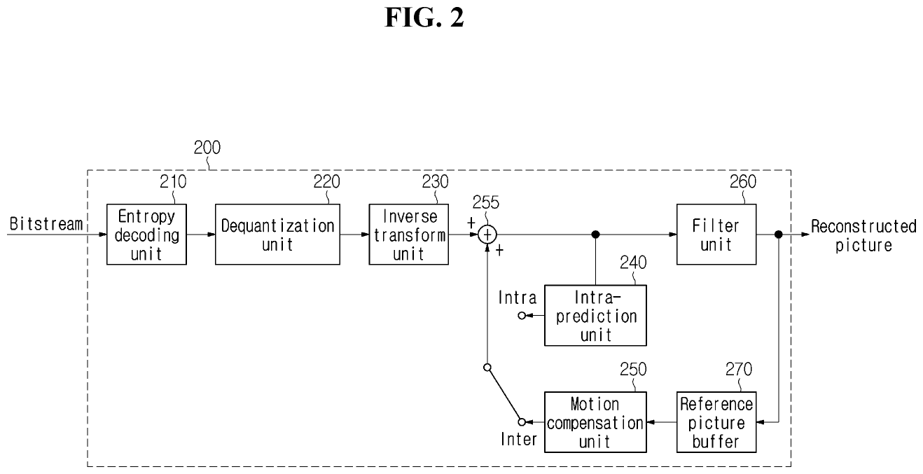

FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse-process of the entropy encoding method described above.

In order to decode a transform coefficient level (quantized level), the entropy decoding unit 210 may change a one-directional vector form coefficient into a two-dimensional block form by using a transform coefficient scanning method. For example, the entropy decoding unit may change vector into a 2D block form by scanning the coefficients of the block using up right scanning. Depending on the size of the transform unit and the intra-prediction mode, vertical scan or horizontal scan may be used instead of upright scan. That is, it may be determined which scan method among upright scan, vertical scan, and horizontal scan is used according to the size of the transform unit and the intra-prediction mode.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing spatial prediction that uses a pixel value of a block adjacent to a decoding target block and which has been already decoded.

When an inter mode is used, the motion compensation unit 250 may generate a prediction block by performing motion compensation that uses a motion vector and a reference image stored in the reference picture buffer 270. When the value of the motion vector is not an integer, the motion compensation unit 250 may generate the prediction block by applying an interpolation filter to a partial region of the reference picture. In order to perform inter prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter prediction or motion compensation may be differently performed depending on the determined mode.

The reconstructed residual block and the prediction block may be added via the adder 255. The block generated by adding the reconstructed residual block and the prediction block may pass the filter 260. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction.

Original signal: means an input signal to be encoded, which is image on the phase signal, in the phase signal encoding and decoding method.

Residual signal: The residual signal may mean the difference between the original signal and the prediction signal. Or the residual signal may be a signal generated by transforming the difference between the original signal and the prediction signal. Or the residual signal may be a signal generated by transforming and quantizing the difference between the original signal and the prediction signal. The residual block may be signal in a unit of block.

First reconstructed signal: may mean reconstructed signal generated by the adder 175 between the decoded residual signal and the prediction signal from the inverse transform unit 170 of FIG. 1. Alternatively, the primary reconstructed signal may mean signal generated by the adder 255 between the decoded residual signal and the prediction signal output from the inverse-transform unit 230 of FIG. 2.

Second reconstructed signal: may mean final reconstructed signal that has passed through the filter unit 180 in FIG. 1, or reconstructed signal stored in the reference picture buffer 190. Alternatively, the second reconstructed signal may mean final reconstructed signal that has passed through the filter unit 260 of FIG. 2 or a reconstructed signal stored in the reference picture buffer 270.

IBDI (Internal Bit-Depth Increase): A technology for providing high-performance coding efficiency and low processing complexity in video codecs and increasing coding efficiency by increasing accuracy by reducing rounding errors by increasing the bit-by-bit internal operation of the input signal in higher bit units. IBDI technology is applied to all coding processes except reference memory and is applied to the floating-point number arithmetic such as the intra prediction, interpolation for ME/MC, transformation, and in-loop filtering to reduce rounding error and increase precision, thereby increasing the coding efficiency.

Memory compression technology: A technology designed to reduce the increase in reference memory size and memory bandwidth according to IBDI application, or to reduce the memory bandwidth generated during ME (motion estimation) and MC (motion compensation) processes even for 8-bit operations.

N (BitDepth): In the method of encoding and decoding a phase signal, the present invention denotes the bit depth (BitDepth) of an original signal to be encoded as n. When the IBDI technology is applied in the video compression process, the bit depth for applying IBDI is set to n.

Range of original signal: the range of an original signal value is equal to or greater than 0 and is equal to or less than 2ⁿ−1.

Range of residual signal: the range of a residual signal value exceeds −2ⁿ and is less than 2^{.}

According to an embodiment, a range of a continuous periodic signal may be expressed as [0, 2π] using a period of 2π. Herein, 0 and 2π have a same value, and only one of them may be included in a range.

Example: [0, 2π), (0, 2π] In the present disclosure, for convenience of description, a range of a continuous periodic signal is expressed by [0, 2π].

In addition, a range of a residual signal between continuous periodic signals may be expressed as [−2π, 2π] using 2π.

According to another embodiment, in a discrete signal, a range of [0, 2n] is expressed as [0, 2ⁿ] according to a bit depth n. Like a continuous periodic signal, since a discrete signal may have such values as 0 and 2ⁿ in consideration of periodicity, it may be expressed by a range including only one of the two values.

Example: [0, 2ⁿ−1], [1, 2ⁿ]

In the present disclosure, for a discrete signal, a range of [0, 2ⁿ−1] is used which can express every signal using nothing but a bit depth n.

In a discrete signal, a range of [−2π, 2π] is expressed as [−2ⁿ, 2ⁿ] according to a bit depth n. Herein, since −2ⁿ, 2ⁿ and 0 are all a same value, a discrete signal may be expressed by a range including only one or two of the values.

Example: [2ⁿ, (2ⁿ−1)], [−(2ⁿ−1), 2ⁿ]

In the present disclosure, a range of [−(2ⁿ−1), (2ⁿ−1)] is used to express every signal using only a bit depth of n+1 for a residual signal range, but many other expression methods like the above embodiment are available.

A digital phase signal has a different feature from a two-dimensional digital image signal that has no periodicity. A phase signal may be expressed by a value of a range [0, 2π] in consideration of periodicity of phase. Since a digital phase signal has a phase range of [−2π, 2π], a phase range of a residual signal may be expressed as [−2π, 2π].

According to the present disclosure, when a signal is expressed as a digital signal, a range of the signal may be expressed as [0, 2ⁿ−1] according to a bit depth n, and a range of the digital signal may be expressed as [−(2ⁿ−1), (2ⁿ−1)].

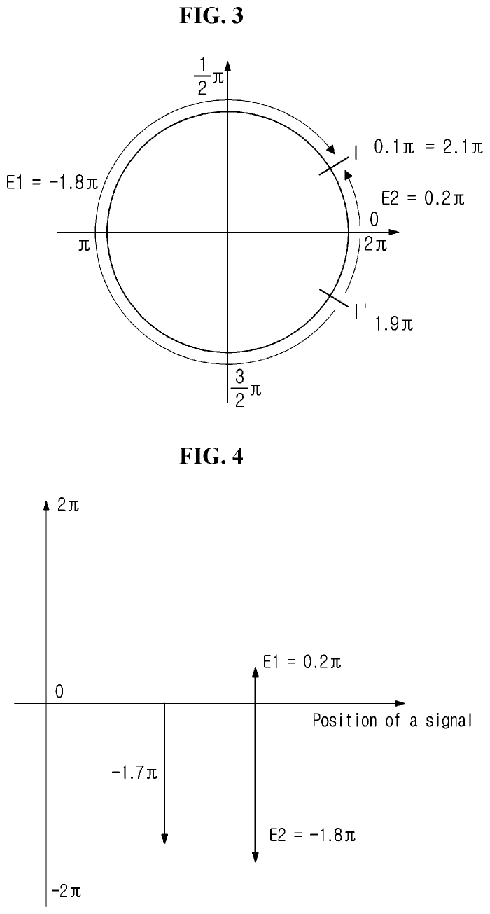

A method of generating a residual signal according to the present disclosure will be described using the examples illustrated in FIG. 3 and FIG. 4.

FIG. 3 and FIG. 4 are views illustrating an embodiment of a candidate of a residual signal that can be selected based on periodicity of a phase signal.

As illustrated in FIG. 3, an original signal (I) and a prediction signal (I′) may be marked by expressing a value of a phase signal by an angle on a unit circle.

Due to periodicity of the signal, a residual signal value between the original signal and the prediction signal may be expressed as various values.

However, in case a range of the residual signal is expressed as [−2π, 2π], a residual signal candidate may select two values, that is, a value exceeding π and a value equal to or smaller than π, as an amplitude of the signal.

As illustrated in FIG. 3, two residual signal candidate values, which can represent a residual signal, correspond to E1 and E2 respectively. As illustrated in FIG. 3, when selecting a residual signal, there are candidates E1 and E2.

As illustrated in FIG. 4, when a neighbor residual signal value is −1.7π, the difference between E1 value and −1.7π is 1.9π, while the difference between E2 value and −1.7π is 0.1π. That is, the value of E2 has a smaller difference from a neighbor signal than that of the value of E1.

As spatial redundancy becomes higher, frequency transformation may have large coefficients concentrated to a lower frequency.

In the present disclosure, to make a transform coefficient generated by the transform unit of FIG. 1 well concentrated in a low-frequency region, compression efficiency may be improved by selecting a signal between two residual signals, which has higher similarity (that is, with smaller difference) to a neighbor residual signal within a residual block.

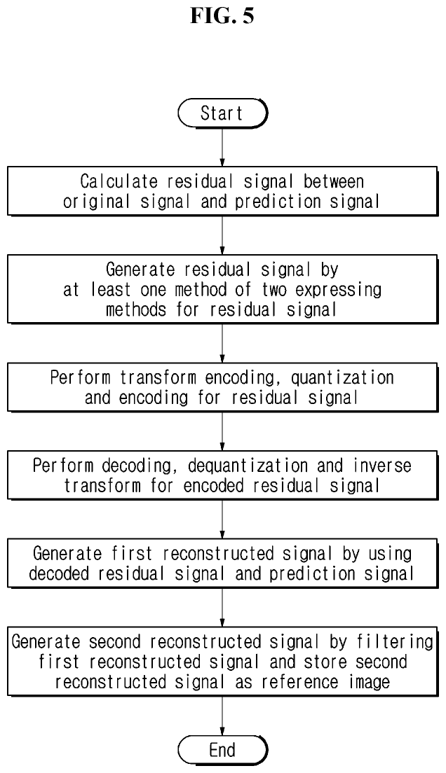

FIG. 5 is a view illustrating an embodiment of a method of generating a residual signal by using periodicity of a signal.

Referring to FIG. 5, at steps S510, an encoding apparatus may calculate a residual signal between an original signal and a prediction signal.

At step S520, the encoding apparatus may generate a residual signal by using at least one of a plurality of methods of expressing a residual signal.

At step S530, the encoding apparatus may perform transformation, quantization and encoding for a residual signal.

At step S540, the encoding apparatus may perform decoding, inverse quantization and inverse transformation for the encoded residual signal.

At step S550, the encoding apparatus may generate a first reconstructed signal by using the decoded residual signal and a prediction signal.

At step S560, the encoding apparatus may generate a second reconstructed signal by filtering the first reconstructed signal and store the generated second reconstructed signal as a reference image. Herein, the encoding apparatus may generate the second reconstructed signal by filtering the first reconstructed signal through a clipping function. According to an embodiment, the clipping function may be a function that has a minimum value of the preset range and a maximum value of the preset range as input values.

Herein, the operations from step S540 to step S560 may be performed by a decoding apparatus. In addition, a digital hologram encoding/decoding method including the operations from step S510 to step S560 and an embodiment of an apparatus for performing the digital hologram encoding/decoding method may be described as follows.

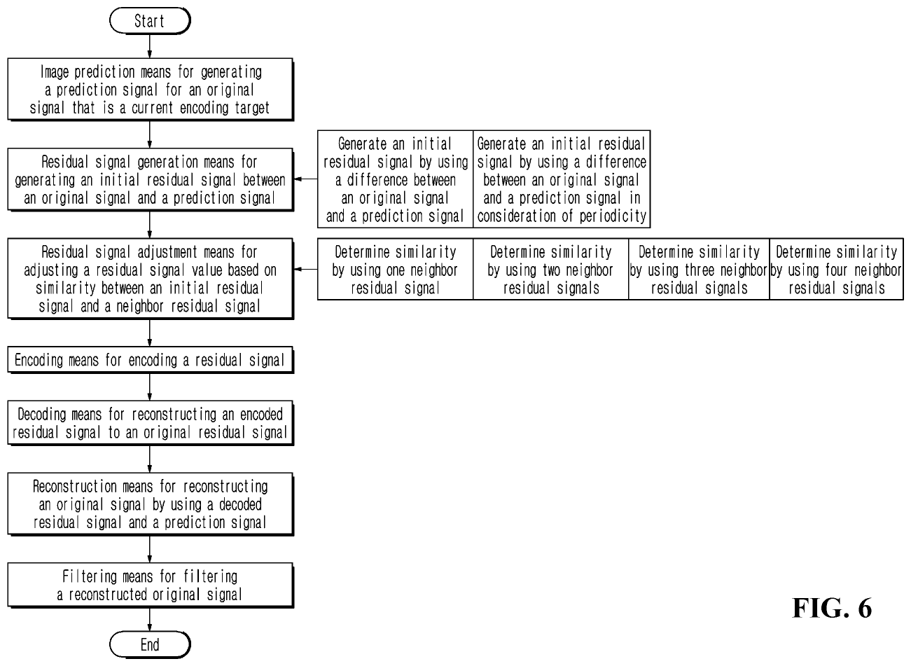

FIG. 6 is a view illustrating an embodiment of a configuration of an apparatus for encoding a digital hologram of an input signal.

An encoding apparatus may include an image prediction means for generating a prediction signal for an original signal that is a current encoding target.

An encoding apparatus may include a residual signal generation means for generating an initial residual signal between an original signal and a prediction signal.

An encoding apparatus may include a residual signal adjustment means for adjusting a residual signal value based on similarity between an initial residual signal and a neighbor residual signal.

An encoding apparatus may include an encoding means for encoding a residual signal.

An encoding apparatus may include a decoding means for reconstructing an encoded residual signal to an original residual signal.

An encoding apparatus may include a reconstruction means for reconstructing an original signal by using a decoded residual signal and a prediction signal.

An encoding apparatus may include a filtering means for filtering a reconstructed original signal.

Herein, a method of generating an initial residual signal by an encoding apparatus may be described as follows.

Specifically, a method of generating, by an encoding apparatus, an initial residual signal by using a difference between an original signal and a prediction signal may be described as follows.

According to the present disclosure, when generating a residual signal for a phase signal by using an original signal and a prediction signal, an encoding apparatus selects a residual signal with higher similarity to a neighbor residual signal between two residual signal values that can be generated due to periodicity. Before selecting a residual signal, an encoding apparatus first generates an initial residual signal that is used to adjust a residual signal.

An encoding apparatus generates an initial residual signal by using an original signal and a prediction signal. An initial residual signal may mean a difference between an original signal and a prediction signal.

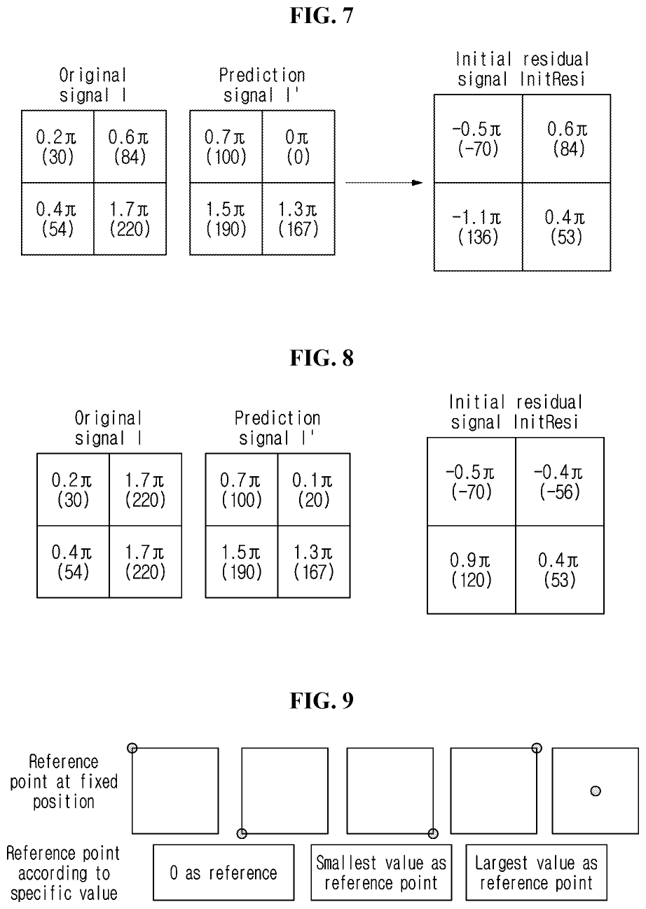

FIG. 7 is an embodiment of generating an initial residual signal based on difference between an original signal and a prediction signal. Herein, a bit depth is assumed to be 8.

An initial residual signal may be calculated as follows.

InitResi:=I−I′ [Equation 1]

Here, I may indicate an original signal, and I′ may indicate a prediction signal.

Specifically, a method of generating, by an encoding apparatus, an initial residual signal by using a difference between an original signal and a prediction signal may be described as follows.

A method of generating, by an encoding apparatus, an initial residual signal by using a difference between an original signal and a prediction signal in consideration of periodicity may be described as follows.

According to the present disclosure, when generating a residual signal for a phase signal by using an original signal and a prediction signal, an encoding apparatus selects a residual signal with higher similarity to a neighbor residual signal between two residual signal values that can be generated due to periodicity. Before selecting a residual signal, an encoding apparatus first generates an initial residual signal that is used to adjust a residual signal. An encoding apparatus generates an initial residual signal by using an original signal and a prediction signal.

An initial residual signal may be every residual signal value that means a same value due to periodicity of signal and has a difference value less than π or can be expressed by periodicity of signal.

In the present disclosure, considering periodicity, a residual signal value with a difference between an original signal and a prediction signal being less than π (or 2ⁿ⁻¹) is an initial residual signal.

FIG. 8 is an embodiment of generating an initial residual signal based on a difference value based on periodicity of an original signal and a prediction signal. Herein, a bit depth is assumed to be 8. Herein, an initial residual signal may be selected as a difference value less than π (or 2ⁿ⁻¹) among difference values based on periodicity of an original signal and a prediction signal. Herein, a bit depth is assumed to be 8.

An initial residual signal may be calculated by the following method.

if (I−I′)>π,InitResi:=(I−I′+π)%(2π)−π

if (I−I′)>−π,InitResi:=(I−I′−π)%(2π)+π

or

if (I−I′)>π,InitResi:=I−I′−2π

if (I−I′)>−π,InitResi:=I−I′+2π [Equation 2]

Here, I may indicate an original signal, and I′ may indicate a prediction signal.

An encoding apparatus may include a residual signal adjustment means for adjusting a residual signal value based on similarity between an initial residual signal and a neighbor residual signal. A method of adjusting a residual signal by an encoding apparatus may be described as follows.

Specifically, a method of adjusting, by an encoding apparatus, a residual signal by using periodicity of signal to spatial similarity of a residual block may be described as follows.

According to the present disclosure, when generating a residual signal for a phase signal by using an original signal and a prediction signal, an encoding apparatus selects a residual signal with higher similarity to a neighbor residual signal between two residual signal values that can be generated due to periodicity. A method of adjusting, by an encoding apparatus, a residual signal by using an initial residual signal is as follows.

According to an embodiment, an encoding apparatus calculates another candidate value, which can be determined as a residual signal, by using an initial residual signal and periodicity.

Another candidate value that can be determined as a residual signal may be calculated as follows.

if InitResi>0,OtherResi:=InitResi−2π

if InitResi<0,OtherResi:=InitResi+2π [Equation 3]

Here, InitResi means the calculated initial residual signal. In addition, OtherResi means another value that can be a residual signal due to periodicity of signal.

For two values that can be determined as a residual signal, an encoding apparatus calculates similarities to a neighbor residual signal respectively by referring to a neighbor residual signal.

A similarity between an initial residual signal and a neighbor residual signal may be calculated as follows.

if k=1,Distance=|R−X|

if k≥2,Distance=Σᵢ₌₁^{k}|Rᵢ−X| [Equation 4]

X means one of candidate values that can be a residual signal. R or Rᵢ means a neighbor residual signal that is referred to. k may indicate the number of neighbor residual signals that are referred to. A neighbor signal thus referred to may be a finally determined residual signal or not. According to the present disclosure, an encoding apparatus may refer only to a finally determined residual signal. Herein, a distance means a similarity, and a smaller distance value corresponds to a higher similarity to a neighbor residual signal.

A distance between an initial residual signal and a neighbor residual signal may be calculated by many other methods of indicating a similarity like the sum of squares of absolute values and the average of absolute values, without being limited to any one method.

An encoding apparatus selects one of two values, which can be a residual signal, and generates it as a residual signal (Resi).

Specifically, an encoding apparatus selects a residual signal value with a higher similarity to a neighbor residual signal among candidate values.

When selecting a residual signal, if there is one neighbor signal that is referred to, an encoding apparatus may simplify an operation of generating the residual signal.

Specifically, in case an initial residual signal value satisfies the condition IR−XI>π, an encoding apparatus selects another residual signal value that is calculated, and otherwise, selects the initial residual signal. X means an initial residual signal. R means a neighbor residual signal that is referred to.

A method of adjusting, by an encoding apparatus, a residual signal by using periodicity of signal to spatial similarity of a residual block may be described as follows.

According to the present disclosure, when generating a residual signal for a phase signal by using an original signal and a prediction signal, an encoding apparatus may select a residual signal with higher similarity to a neighbor residual signal between two residual signal values that can be generated due to periodicity of signal. A method of adjusting, by an encoding apparatus, a residual signal by using an initial residual signal may be described as follows.

An encoding apparatus may calculate another residual signal value, which can be determined as a residual signal, by using periodicity.

Another residual signal value, which can be determined as a residual signal, may be calculated as described below.

if InitResi>0,OtherResi:=InitResi−2ⁿ

if InitResi<0,OtherResi:=InitResi+2ⁿ [Equation 5]

InitResi means the calculated initial residual signal. OtherResi means another value that can be a residual signal due to periodicity of signal.

When a residual signal has a value of 0, 2ⁿ or −2ⁿ, since the value of 2ⁿ exceeds a range of an expressible signal value, the value of the residual value may be expressed by using 0 alone in order to reduce a representation bit depth.

For two values that can be determined as a residual signal, an encoding apparatus may calculate similarities to a neighbor residual signal respectively by referring to a neighbor residual signal.

A method of calculating a similarity to a neighbor residual signal is as follows.

if k=1,Distance=|R−X|

if k≥2,Distance=Σᵢ₌₁^{k}|Rᵢ−X| [Equation 6]

X means one of candidate values that can be a residual signal. R or Rᵢ means a neighbor residual signal that is referred to. In addition, k indicates the number of neighbor residual signals. A neighbor signal thus referred to may be a finally determined residual signal or not. According to the present disclosure, an encoding apparatus may refer only to a finally determined residual signal. Herein, a distance means a similarity, and a smaller distance value of a signal corresponds to a higher similarity to a neighbor residual signal.

A distance between an initial residual signal and a neighbor residual signal may be calculated by many other methods of indicating a similarity like the sum of squares of absolute values and the average of absolute values, without being limited to any one method.

An encoding apparatus selects one of two values, which can be a residual signal, and generates it as a residual signal (Resi).

Specifically, an encoding apparatus selects a residual signal value with a smaller calculated distance (that is, a higher similarity) among candidate values.

When selecting a residual signal, if there is one neighbor signal that is referred to, an encoding apparatus may simplify an operation of generating the residual signal.

Specifically, in case an initial residual signal value satisfies the condition |R−X|>2ⁿ⁻¹, an encoding apparatus selects another residual signal value that is calculated, and otherwise, selects the initial residual signal. X means an initial residual signal. R means a neighbor residual signal that is referred to.

A method of adjusting, by an encoding apparatus, a residual signal by using periodicity of signal to spatial similarity of a residual block may be described as follows.

An encoding apparatus may determine a reference scheme when referring to a neighbor residual signal. A reference scheme may be determined based on the number of signals that are referred to, a reference direction, a reference distance, and a reference point. The number of signals that are referred to may be one or more.

A referred residual signal may be a residual signal that is finally determined or a residual signal that is not finally determined.

A reference direction may indicate a direction where a neighbor reference signal is to be referred to. An encoding apparatus may refer to a neighbor residual signal in one or more directions at a time.

A reference distance may indicate a distance a neighbor residual signal to be referred to is from a current residual signal position.

A reference point means a residual signal that is first referred to in each reference direction, without applying a residual signal generation algorithm using periodicity of signal. Herein, there may be one or more reference points.

A method of determining a reference point may be described as follows.

FIG. 9 is a view illustrating an embodiment of a method of determining a reference point.

According to an embodiment illustrated in FIG. 9, an encoding apparatus may determine a point with a specific fixed position as a reference point. Herein, the fixed position may be at least one point among points that are located in top left, bottom left, bottom right, top right and center positions.

According to another embodiment, an encoding apparatus may determine a point with a specific value, not a fixed position, as a reference point. Herein, the specific value may be at least one of 0, a smallest value, and a largest value.

An encoding method of an encoding apparatus, which generates a residual signal according to a reference scheme, may be described as follows. Herein, a bit depth n is assumed to be 8.

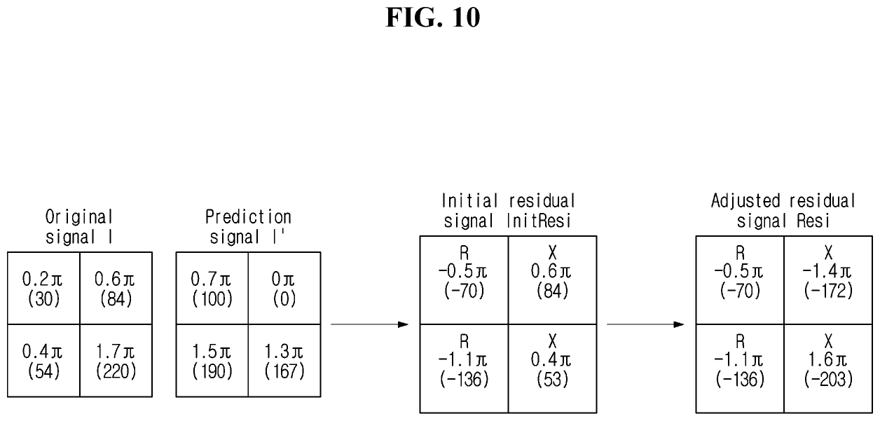

FIG. 10 is a view illustrating an embodiment of a method of generating a residual signal according to a referencing method.

Specifically, FIG. 10 is a view illustrating an example of referring to one neighbor residual signal that is one space apart on the left of X. Herein, leftmost residual signals are a reference point.

An initial residual signal may be a difference value (I−I′) between an original signal and a prediction signal. Among initial residual signals, −70 and −136 are reference points to which no residual signal generation algorithm considering periodicity of signal is applied.

When periodicity of signal is reflected, a residual signal corresponding to an initial residual signal 84 becomes 84-256=−172. Similarities (distances) for 84 and −172 may be calculated respectively as follows.

Distance₈₄=|R−X|=|−70−84|=154

Distance₋₁₇₂=|R−X|=|−70+172|=102 [Equation 7]

X means one of candidate values that can be a residual signal. R means a neighbor residual signal that is referred to. That is, the adjusted residual signal −172 has a higher similarity than that of the initial residual signal 84. Accordingly, the adjusted residual signal −172 may be selected as a residual signal.

### Embodiment [E3-2]

A residual signal adjustment method, by which an encoding apparatus determines similarity between residual signals by using two neighbor residual signals, may be described as follows.

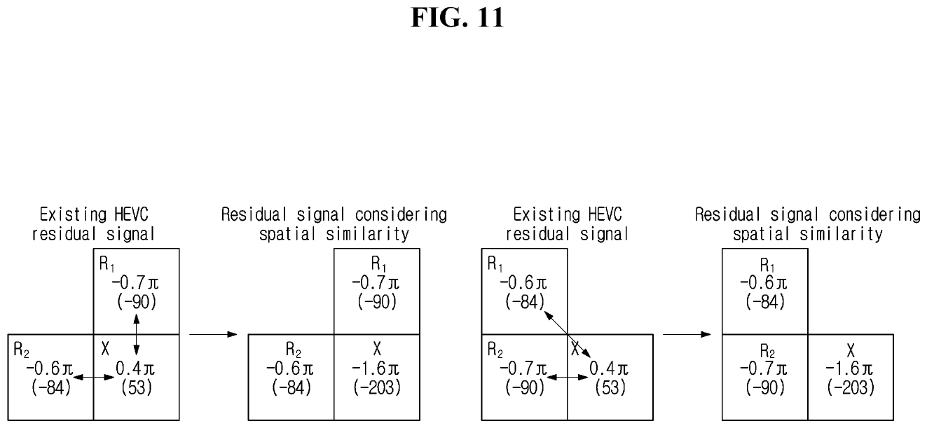

FIG. 11 is a view illustrating an embodiment of a residual signal adjustment method that determines similarity between residual signals by using two neighbor residual signals. Herein, a bit depth n is assumed to be 8.

FIG. 11 is an example of referring to two neighbor residual signals that are one space apart from X. As illustrated herein, a reference point may consist of two neighbor residual signals. An encoding apparatus may determine a direction of a reference point among residual signals.

When periodicity of signal is reflected, a residual signal corresponding to 53 calculated according to the existing HEVC residual signal generation scheme becomes 53−256=−203. Similarities (distances) for 53 and −203 may be calculated respectively as follows.

distance₅₃=Σᵢ₌₁²|Rᵢ−X|=|−84−53|+|−90−53|=280

distance₋₂₀₃=Σᵢ₌₁²|Rᵢ−X|=|−84+203|+|−90+203|=232 [Equation 8]

X means one of candidate values that can be a residual signal. Rᵢ means a neighbor residual signal that is referred to. That is, the adjusted residual signal −203 has a higher similarity than that of the initial residual signal 53. Accordingly, the adjusted residual signal −203 may be selected as a residual signal.

### Embodiment [E3-3]

A residual signal adjustment method, by which an encoding apparatus determines similarity between residual signals by using three neighbor residual signals, may be described as follows.

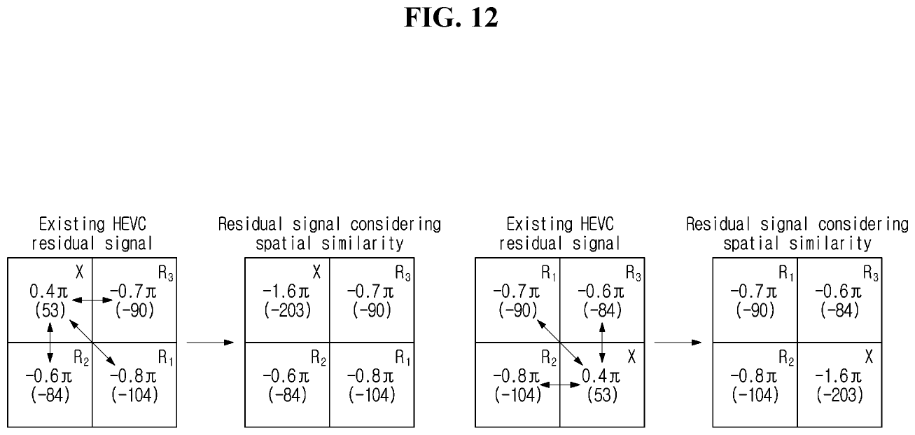

FIG. 12 is a view illustrating an embodiment of a residual signal adjustment method that determines similarity between residual signals by using three neighbor residual signals. Herein, a bit depth n is assumed to be 8.

FIG. 12 is a view illustrating an example of referring to three neighbor residual signals that are one space apart from X. As illustrated herein, a reference point may consist of three neighbor residual signals. An encoding apparatus may determine a direction of a reference point among residual signals.

When periodicity of signal is reflected, a residual signal corresponding to 53 calculated according to the existing HEVC residual signal generation scheme becomes 53−256=−203.

Similarities (distances) for 53 and −203 may be calculated respectively as follows.

distance₅₃=Σᵢ₌₁³|Rᵢ−X|=|−84−53|+|−90−53|+|−104−53|=437

distance₋₂₀₃=Σᵢ₌₁³|Rᵢ−X|=|−84+203|+|−90+203|+|−104+203|=331 [Equation 9]

X means one of candidate values that can be a residual signal. Rᵢ means a neighbor residual signal that is referred to. That is, the adjusted residual signal −203 has a higher similarity than that of the initial residual signal 53. Accordingly, the adjusted residual signal −203 may be selected as a residual signal.

### Embodiment [E3-4]

A residual signal adjustment method, by which an encoding apparatus determines similarity between residual signals by using four neighbor residual signals, may be described as follows.

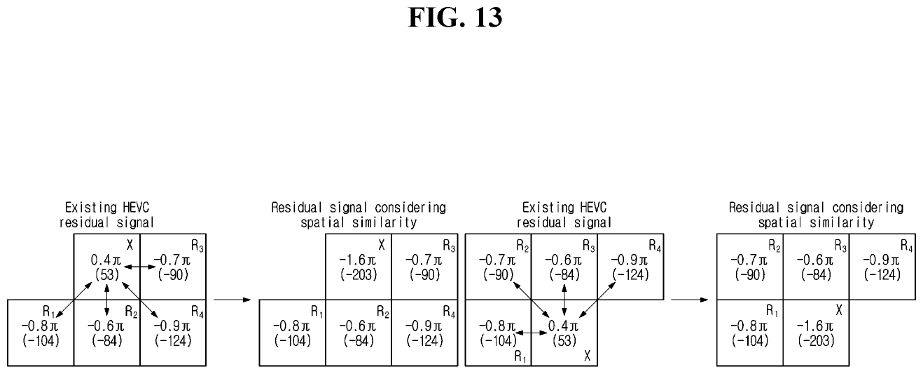

FIG. 13 is a view illustrating an embodiment of a residual signal adjustment method that determines similarity between residual signals by using four neighbor residual signals. Herein, a bit depth n is assumed to be 8.

FIG. 13 is an example of referring to two neighbor residual signals that are one space apart from X. As illustrated herein, a reference point may consist of two neighbor residual signals. An encoding apparatus may determine a direction of a reference point among residual signals.

When periodicity of signal is reflected, a residual signal corresponding to 53 calculated according to the existing HEVC residual signal generation scheme becomes 53-256=−203. Similarities (distances) for 53 and −203 may be calculated respectively as follows.

distance₅₃=Σᵢ₌₁⁴|Rᵢ−X|=|−84−53|+|−90−53|+|−104−53|+|−124−53|=437

distance₋₂₀₃=Σᵢ₌₁⁴|Rᵢ−X|=|−84+203|+|−90+203|+|−104+203|+|−124+203|=410 [Equation 10]

X means one of candidate values that can be a residual signal. Rᵢ means a neighbor residual signal that is referred to. That is, the adjusted residual signal −203 has a higher similarity than that of the initial residual signal 53. Accordingly, the adjusted residual signal −203 may be selected as a residual signal.

According to the present disclosure, when generating a residual signal for a phase signal by using an original signal and a prediction signal, an encoding apparatus may select a residual signal with higher similarity to a neighbor residual signal between two residual signal values that can be generated due to periodicity. An algorithm of generating a residual signal may be as follows.

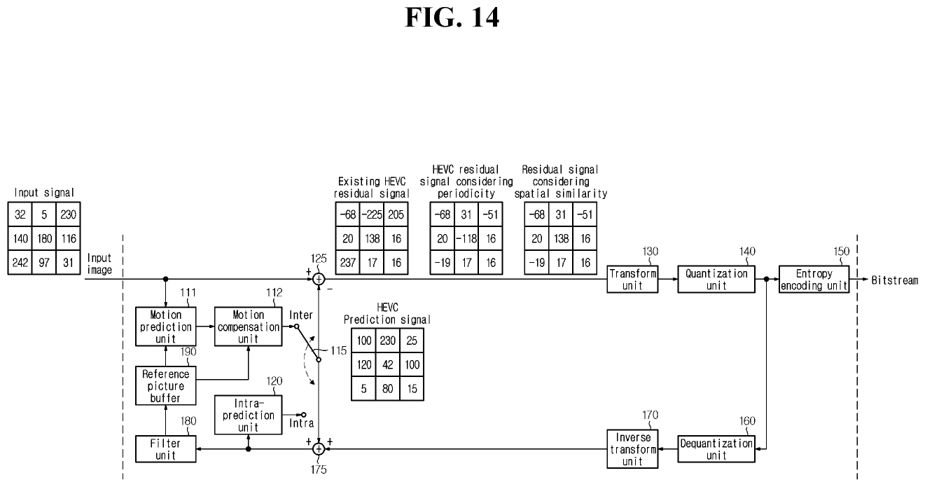

FIG. 14 is a view illustrating an embodiment of a method of generating a residual signal by considering spatial similarity.

In the embodiment of FIG. 14, a bit depth n is assumed to be 8.

Referring to the embodiment of FIG. 14, an encoding apparatus may generate a residual signal based on an input signal and a prediction signal (e.g., a prediction signal according to the HEVC standard). Considering periodicity of signal, the encoding apparatus may generate a residual signal considering periodicity based on the generated residual signal. In addition, the encoding apparatus may generate a residual signal considering spatial similarity between residual signals.

In the present disclosure, a range of an initial residual signal is expressed in a form of [−π, π] in consideration of periodicity. However, an initial residual signal may be expressed as a signal in many other various ranges considering periodicity.

In the present disclosure, an adjusted range of a final residual signal may be expressed as [−2π, 2π] to reduce a bit depth. However, a range of a final residual signal may be expressed by anther range. A method of the present disclosure is not limited to a single range expression scheme.

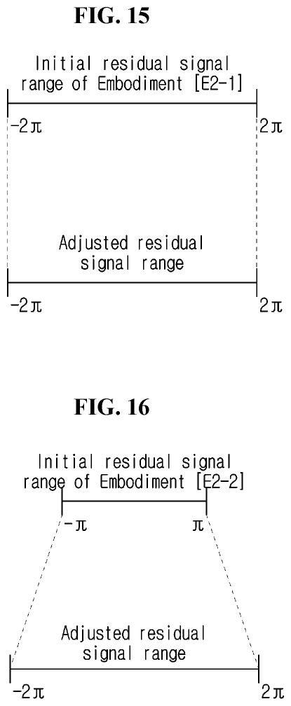

FIG. 15 and FIG. 16 are views illustrating an embodiment of an adjusted residual signal range that is calculated by adjusting a range of an initial residual signal.

FIG. 15 is a view illustrating an example of generating a range of an initial residual signal as [−2π, 2π].

FIG. 16 is a view illustrating an example of generating a range of an initial residual signal as [−π, π].

[−2π, 2π] becomes a range of a final residual signal that is adjusted from the ranges of initial residual signals illustrated in FIG. 15 and FIG. 16.

Expression of Residual Phase Range

A range of a residual signal used in the present disclosure is not limited to the range [−2π, 2π], and a residual signal with a wider phase range may also be used.

That is, an encoding apparatus may use any residual signal with periodicity.

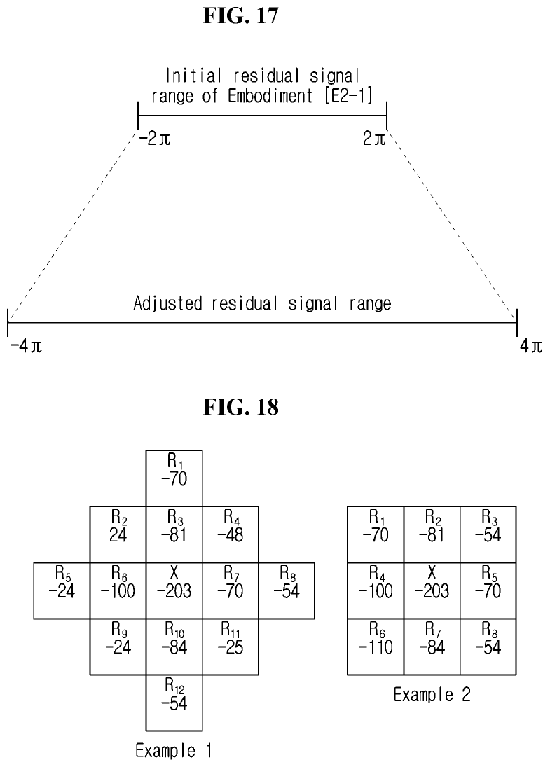

FIG. 17 is a view illustrating an embodiment of an adjusted residual signal range that is calculated by adjusting a range of an initial residual signal.

FIG. 17 is an example of transforming the range [−2π, 2π] of a residual signal into [−4π, 4π]. The above-described Resi′ value may be used by being defined as follows.

Resi′=Resi±period(−4π<Resi′<4π),period=2π or 4π

Distance=Σᵢ₌₁^{k}|Refᵢ−Resi| [Equation 11]

Here, Resi may indicate a residual signal, and Resi′ may indicate a residual signal with an adjusted range. In addition, Refᵢ means a neighbor residual signal that is referred to. That is, according to the present disclosure, an encoding apparatus may use a residual signal adjustment method of the present disclosure by setting a value of 2π, which is a period of a signal, to correspond to a range of a residual signal.

When a range of a residual signal is adjusted as exemplified in FIG. 17, the correlation between the residual signal and a neighbor signal may be increased. However, a bit rate used for expressing an adjusted range of a residual signal may be increased.

Number of signals that are referred to

In the present disclosure, an example of using 1 to 4 neighbor residual signals is described, but a residual signal may be adjusted using more neighbor residual signals.

FIG. 18 is a view illustrating an embodiment of a residual signal adjustment method that determines similarity between residual signals by using five or more neighbor residual signals.

Herein, a bit depth n is assumed to be 8.

When the similarity formula of Equation 6 is applied to Example 1 and Example 2 illustrated in FIG. 18, a residual signal may be adjusted as illustrated in FIG. 18.

Herein, X means one of values that can be a residual signal. R or Rᵢ means a neighbor residual signal that is referred to.

Combination of Referencing Methods

A method of the present disclosure may be used by combining the number of reference signals, a reference direction, a reference distance, and a reference point in various ways.

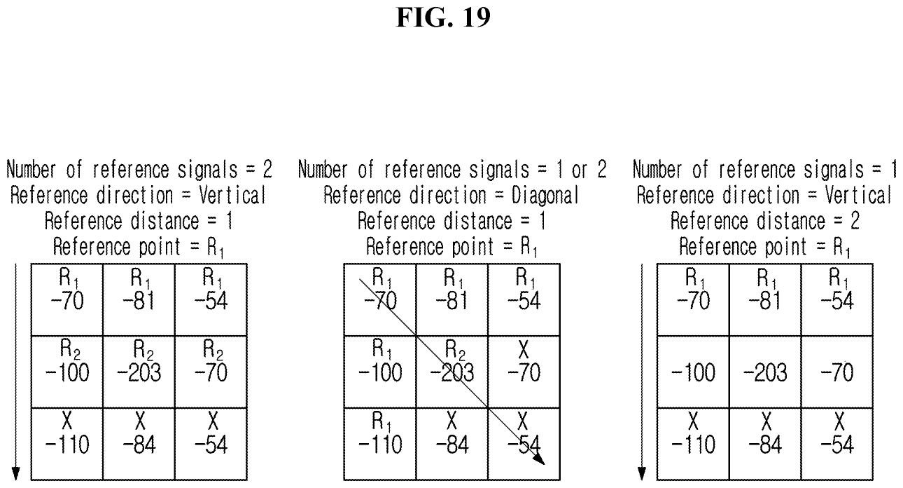

FIG. 19 is a view illustrating embodiments of a referencing method of a residual signal.

According to an embodiment, a referencing method of a residual signal may have two reference signals, a vertical reference direction, a reference distance of 1, and a reference point of R₁. According to another embodiment, a referencing method of a residual signal may have one or two reference signals, a diagonal reference direction, a reference distance of 1, and a reference point of R₁. According to yet another embodiment, a referencing method of a residual signal may have one reference signal, a vertical reference direction, a reference distance of 2, and a reference point of R₁.

Description of HEVC

Description of Terms—Terms for the HEVC standard. The relationship between terms used in the standard and terms used in the invention is as follows.

Clipping: means cutting off the exceeding value of the signal. In the present invention, clipping means a process of converting a value into a value within a range when a value exceeds a corresponding range.

recSamples: may mean a first reconstructed signal generated via the adder 255. Alternatively, it may mean a second reconstructed signal.

predSamples: means a prediction signal.

resSamples: means a residual signal.

Clip3(x,y,z): A function that receives a minimum value (x), a maximum value (y), and a signal (z) as inputs and outputs a converted value by clipping the signal value. If the signal value is less than the minimum value, the signal value is converted to the minimum value, if the signal value is greater than the maximum value, the signal value is converted to the maximum value, and in other cases, the signal value is converted to the signal value and outputted.

BitDepth_Y: means the BitDepth (n) of the luma component signal.

BitDepth_C: BitDepth (n) of chroma component signal.

Clip1_Y(x): A function that receives a luma component signal (x) as an input and outputs a converted value by clipping a range of the input signal.

Clip1_C(x): A function that receives a chroma component signal (x) as an input and outputs a converted value by clipping for a range of the input signal.

clipCidx1: Means Clip1_Y or Clip1_C.

xCurr: means the x position of the signal block to be reconstructed.

yCurr: means the y position of the signal block to be reconstructed.

nCurrSw×nCurrSh: means the size of the signal block to be reconstructed.

In HEVC, the following clipping function is conventionally used in a process of generating a first reconstructed signal.

$$Clip 3 ( x , y , z ) = \{ \begin{matrix}x ; & z < x \\ y ; & z > y \\ z ; & otherwise\end{matrix} \qquad [ Equation 12 ]$$

$$Clip {1}_{Y} ( x ) = Clip 3 ( 0 , ( 1 ≪ {BitDepth}_{Y} ) - 1 , x )$$

$$Clip {1}_{C} ( x ) = Clip 3 ( 0 , ( 1 ≪ {BitDepth}_{C} ) - 1 , x )$$

$$recSamples [ xCurr + i ] [ yCurr + j ] = clipCidx 1 ( predSamples [ i ] [ j ] + recSamples [ i ] [ j ]$$

$$with i = 0 … nCurrSw - 1 , j = 0 … nCurrSh - 1$$

$$with i = 0 … nCurrSw - 1 , j = 0 …nCurrSh - 1$$

According to an embodiment of the present disclosure, when a first reconstructed signal is generated by using a residual signal and a prediction signal for a signal with periodicity, the following clipping function, which is modified by considering periodicity, may be used.

$$Clip 3 \_ Phase ( min Val , max Val , x ) = \{ \begin{matrix}x ; & min Val \leq x \leq max Val \\ x \% ( max Val + 1 ) ; & x > max Val \\ x \% ( max Val + 1 ) + ( max Val + 1 ) ; & x < min Val\end{matrix} \qquad [ Equation 13 ]$$

$${ClipBD\_Phase}_{Y} ( x ) = Clip 3 \_ Phase ( 0 , ( 1 ≪ {BitDepth}_{Y} ) - 1 , x )$$

$${ClipBD\_Phase}_{C} ( x ) = Clip 3 \_ Phase ( 0 , ( 1 ≪ {BitDepth}_{C} ) - 1 , x )$$

$$recSamples [ xCurr + i ] [ yCurr + j ] = clipCidx 1 ( predSamples [ i ] [ j ] + recSamples [ i ] [ j ]$$

$$with i = 0 … nCurrSw - 1 , j = 0 … nCurrSh - 1$$

$$with i = 0 … nCurrSw - 1 , j = 0 … nCurrSh - 1$$

The function Clip3_Phase may be a function of performing clipping by using minVal, a minimum value of a signal range, maxVal, a maximum value of the signal range, and an input value x. When the x value is within the signal range, the clipping function may output the x value. When the x value exceeds the maximum value of the signal range, the clipping function may output a x % (maxVal+1) value. When the x value is less than the minimum value of the signal range, the clipping function may output a value of x % (maxVal+1)+(maxVal+1).

That is, an image encoding apparatus or an image decoding apparatus may generate a reconstructed signal (e.g., second reconstructed signal) transformed from a value of the initial reconstructed signal (e.g, first reconstructed signal) by a clipping function that uses the minimum value of a preset range and the maximum value of the preset range as input values.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

Various embodiments of the present disclosure are intended to explain representative aspects of the present disclosure, rather than listing all possible combinations, and matters described in various embodiments may be applied independently or in a combination of two or more.

In addition, various embodiments of the present disclosure may be implemented by hardware, firmware, software, or a combination thereof. For hardware implementation, may be implemented by one or more application-specific integrated circuits (ASICs), digital signal processors (DSPs), digital signal processing devices (DSPDs), programmable logic devices (PLDs), field programmable gate arrays (FPGAs), processor (general processor), controller, microcontroller, microprocessor, or the like.

The scope of the present disclosure includes software or machine-executable instructions (e.g., operating system, application, firmware, program, etc.) that cause operations according to methods of various embodiments to be executed on a device or computer, or non-transitory computer-readable medium executable on a device or computer storing software or instruction.

What is claimed is:

1. A method for decoding an image, the method comprising:
generating a prediction signal for a current signal;
decoding an encoded residual signal from a bitstream;
generating an initial reconstructed signal based on the prediction signal and the residual signal; and
generating a transformed reconstructed signal by transforming a value of the initial reconstructed signal to have a size value of a preset range,
wherein the generating of the transformed reconstructed signal generates the transformed reconstructed signal from the value of the initial reconstructed signal by using a clipping function with a minimum value of the preset range and a maximum value of the preset range as input values, and
wherein the preset range is a period range of a signal.

2. The method of claim 1, wherein the residual signal is a signal that is adjusted based on a similarity between neighbor residual signals of a region adjacent to the residual signal.

3. The method of claim 2, wherein the residual signal is a signal that is adjusted based on at least one of a number of neighbor residual signals that are referred to, a direction of referring to a neighbor residual signal, a reference distance, and a reference point.

4. The method of claim 3, wherein the reference point is determined based on at least one of a position of a signal and a value of a signal.

5. A method for encoding an image, the method comprising:
generating a prediction signal for an input signal;
generating an initial residual signal based on the input signal and the prediction signal;
adjusting the initial residual signal based on a neighbor residual signal value that is a residual signal for a signal of a region adjacent to the input signal; and
encoding the adjusted residual signal.

6. The method of claim 5, wherein the initial residual signal is generated by considering periodicity of the input signal and the prediction signal.

7. The method of claim 6, wherein a size of the initial residual signal is generated so as not to exceed a maximum value of a period range of the input signal and the prediction signal.

8. The method of claim 5, wherein the adjusting of the initial residual signal adjusts a value of the initial residual signal based on a similarity between the initial residual signal and the neighbor residual signal.

9. The method of claim 8, wherein the adjusting of the initial residual signal adjusts the initial residual signal based on at least one of a number of neighbor residual signals that are referred to, a direction of referring to a neighbor residual signal, a reference distance, and a reference point.

10. The method of claim 9, wherein the reference point is determined based on at least one of a position of a signal and a value of a signal.

11. The method of claim 9, wherein the adjusting of the initial residual signal determines whether or not to adjust the initial residual signal based on a similarity between the neighbor residual signal and each of the adjusted residual signal that is generated by adjusting the initial residual signal based on the initial residual signal and periodicity of the signal.

12. The method of claim 11, wherein the adjusting of the initial residual signal determines to use the adjusted residual signal, when a similarity between the adjusted residual signal and the neighbor residual signal is higher than a similarity between the initial residual signal and the neighbor residual signal.

13. The method of claim 11, wherein the similarity is determined based on a sum of a distance for at least one of each of the neighbor residual signal.

14. The method of claim 5, comprising:
decoding the adjusted residual signal that is encoded;
generating an initial reconstructed signal based on the prediction signal and the adjusted residual signal; and
generating a transformed reconstructed signal by transforming a value of the initial reconstructed signal to have a size value in a preset range,
wherein the generating of the transformed reconstructed signal generates the transformed reconstructed signal from the value of the initial reconstructed signal by using a clipping function that has a minimum value of the preset range and a maximum value of the preset range as input values.

15. A recording medium storing a bitstream generated by an image encoding method, wherein the image encoding method comprises:
generating a prediction signal for an input signal;
generating an initial residual signal based on the input signal and the prediction signal;
adjusting the initial residual signal based on a neighbor residual signal value that is a residual signal for a signal of a region adjacent to the input signal; and
encoding the adjusted residual signal.
